(19) United States
(12) Patent Application Publication
(10) Pub. No.: US 2016/0327082 A1
(43) Pub. Date: Nov. 10, 2016

(54) RADIAL PINCH BOLT HEAD SEAL

(71) Applicant: United Technologies Corporation, Hartford, CT (US)

(72) Inventors: Justin J. Phillips, West Suffield, CT (US); Todd A. Davis, Tolland, CT (US)

(21) Appl. No.: 14/706,636

(22) Filed: May 7, 2015

(51) Int. Cl. F16B 33/00

(52) U.S. Cl. CPC F16B 33/004

(57) ABSTRACT

Aspects of the disclosure are directed to an assembly associated with an engine of an aircraft, comprising a bolt comprising at least one groove, and at least one seal seated within the at least one groove, where the at least one seal is configured to seal radially against a counter bore that the bolt is coupled to. Aspects of the disclosure are directed to a bolt comprising a head, a first groove formed in a first side of the head and configured to seat a first seal, and an internal feature formed in the head and interfacing with a surface of the head, where the internal feature is configured to enable the bolt to be tightened.

### BACKGROUND

In connection with an aircraft engine, a bearing compartment may be used to support one or more portions of an engine. Oil is provided to the bearing compartment for purposes of cooling, lubricating, and cleaning one or more bearings or associated bearing surfaces. Bolts are used in conjunction with the bearing compartment and serve as an attachment mechanism. A bolt that passes through a bearing compartment wall creates a potential leak path for oil inside the bearing compartment to find its way passed a head of the bolt, through threads of the bolt, and out of the bearing compartment.

It is important to keep oil inside the bearing compartment due at least in part to the high temperatures that may exist outside of the bearing compartment. One or more seals can be used for this purpose. Conventionally, seals may be located underneath the bolt head. These seals depend on a torque or preloading of the bolt to engage or crush the seals. If the bolt is loose or begins to “back out” (either at initial engine assembly or over the operative life of the engine), the interface formed by the bolt and the seal will become ineffective and may lead to oil leaking out of the bearing compartment.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to an assembly associated with an engine of an aircraft, comprising a bolt comprising at least one groove, and at least one seal seated within the at least one groove, where the at least one seal is configured to seal radially against a counter bore that the bolt is coupled to. In some embodiments, the at least one groove is formed in a head of the bolt. In some embodiments, the at least one groove is formed in a side of the head. In some embodiments, the at least one groove comprises at least two grooves, and the at least one seal comprises a first seal seated within a first of the at least two grooves and a second seal seated within a second of the at least two grooves. In some embodiments, the assembly further comprises an internal feature configured to enable the bolt to be tightened. In some embodiments, the internal feature is formed in a head of the bolt. In some embodiments, the internal feature is compliant with one of a hex profile, a 6-point star-shaped profile, a flat screwdriver profile, or a Phillips head profile. In some embodiments, the assembly is incorporated into a bearing compartment of the engine. In some embodiments, the assembly is configured to prevent oil contained within the bearing compartment from leaking out of the bearing compartment. In some embodiments, the at least one seal comprises at least one of an o-ring seal or a c-seal. In some embodiments, the at least one seal comprises a metallic seal. In some embodiments, the at least one seal comprises a non-metallic seal.

Aspects of the disclosure are directed to a bolt comprising a head, a first groove formed in a first side of the head and configured to seat a first seal, and an internal feature formed in the head and interfacing with a surface of the head, where the internal feature is configured to enable the bolt to be tightened. In some embodiments, the bolt is configured to be incorporated into an engine of an aircraft. In some embodiments, the bolt is configured to be incorporated into a bearing compartment of the engine. In some embodiments, the internal feature is compliant with one of a hex profile, a 6-point star-shaped profile, a flat screwdriver profile, or a Phillips head profile. In some embodiments, the bolt further comprises a second groove formed in a second side of the head and configured to seat a second seal, where the second side of the head is substantially diametrically opposite the first side of the head. In some embodiments, the first groove is configured to seat the first seal such that the first seal seals radially against a counter bore. In some embodiments, the first groove is configured to seat an o-ring seal or a c-seal as the first seal

### BRIEF DESCRIPTION OF THE DRAWINGS

The present disclosure is illustrated by way of example and not limited in the accompanying figures in which like reference numerals indicate similar elements.

FIG. 1 is a side cutaway illustration of a geared turbine engine.

FIG. 2 illustrates an exemplary sealing assembly.

FIG. 3 illustrates a bearing compartment including the incorporation of the sealing assembly of FIG. 2.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, apparatuses, systems, and methods are described for providing an interface/assembly for a bearing compartment. The assembly may include a bolt with a groove. The groove may be formed in a side of, or below, the bolt head. The groove may be configured to accept/seat one or more seals that may be included as part of the assembly. The bolt may include a feature (e.g., an internal feature) that may be used for tightening purposes.

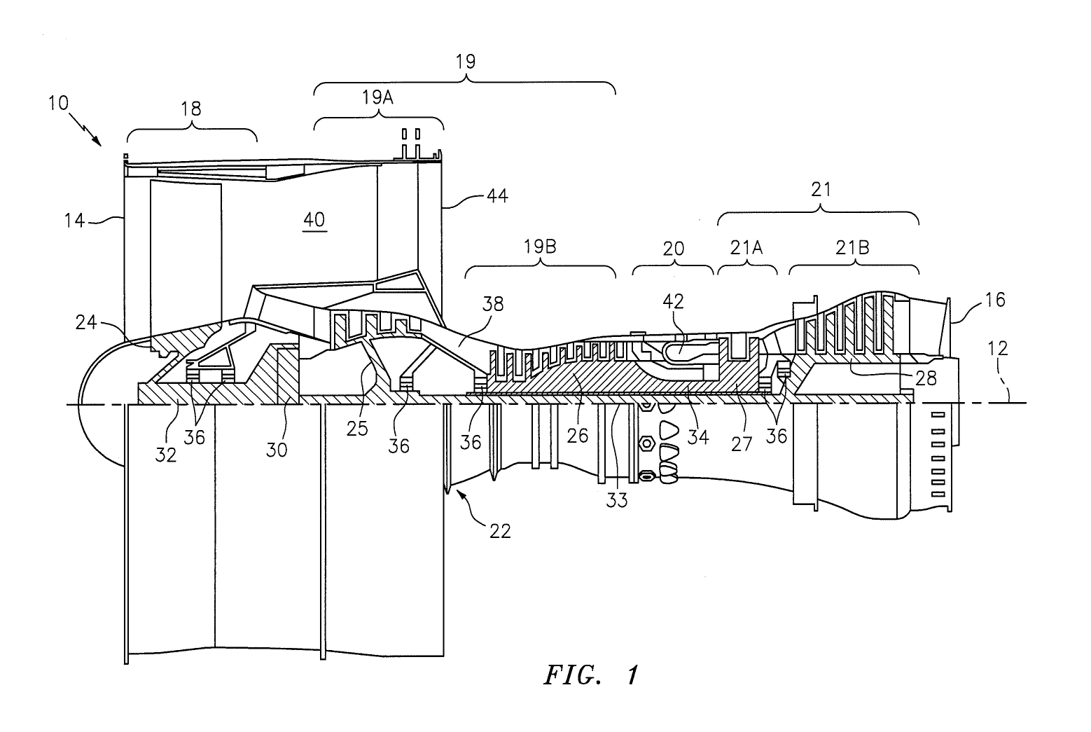

Aspects of the disclosure may be applied in connection with a gas turbine engine. FIG. 1 is a side cutaway illustration of a geared turbine engine 10. This turbine engine 10 extends along an axial centerline 12 between an upstream airflow inlet 14 and a downstream airflow exhaust 16. The turbine engine 10 includes a fan section 18, a compressor section 19, a combustor section 20 and a turbine section 21. The compressor section 19 includes a low pressure compressor (LPC) section 19A and a high pressure compressor (HPC) section 19B. The turbine section 21 includes a high pressure turbine (HPT) section 21A and a low pressure turbine (LPT) section 21B.

The engine sections 18-21 are arranged sequentially along the centerline 12 within an engine housing 22. Each of the engine sections 18-19B, 21A and 21B includes a respective rotor 24-28. Each of these rotors 24-28 includes a plurality of rotor blades arranged circumferentially around and connected to one or more respective rotor disks. The rotor blades, for example, may be formed integral with or mechanically fastened, welded, brazed, adhered and/or otherwise attached to the respective rotor disk(s).

The fan rotor 24 is connected to a gear train 30, for example, through a fan shaft 32. The gear train 30 and the LPC rotor 25 are connected to and driven by the LPT rotor 28 through a low speed shaft 33. The HPC rotor 26 is connected to and driven by the HPT rotor 27 through a high speed shaft 34. The shafts 32-34 are rotatably supported by a plurality of bearings 36; e.g., rolling element and/or thrust bearings. Each of these bearings 36 is connected to the engine housing 22 by at least one stationary structure such as, for example, an annular support strut.

During operation, air enters the turbine engine 10 through the airflow inlet 14, and is directed through the fan section 18 and into a core gas path 38 and a bypass gas path 40. The air within the core gas path 38 may be referred to as “core air”. The air within the bypass gas path 40 may be referred to as “bypass air”. The core air is directed through the engine sections 19-21, and exits the turbine engine 10 through the airflow exhaust 16 to provide forward engine thrust. Within the combustor section 20, fuel is injected into a combustion chamber 42 and mixed with compressed core air. This fuel-core air mixture is ignited to power the turbine engine 10. The bypass air is directed through the bypass gas path 40 and out of the turbine engine 10 through a bypass nozzle 44 to provide additional forward engine thrust. This additional forward engine thrust may account for a majority (e.g., more than 70 percent) of total engine thrust. Alternatively, at least some of the bypass air may be directed out of the turbine engine 10 through a thrust reverser to provide reverse engine thrust.

FIG. 1 represents one possible configuration for an engine 10. Aspects of the disclosure may be applied in connection with other environments, including additional configurations for an engine of an aircraft.

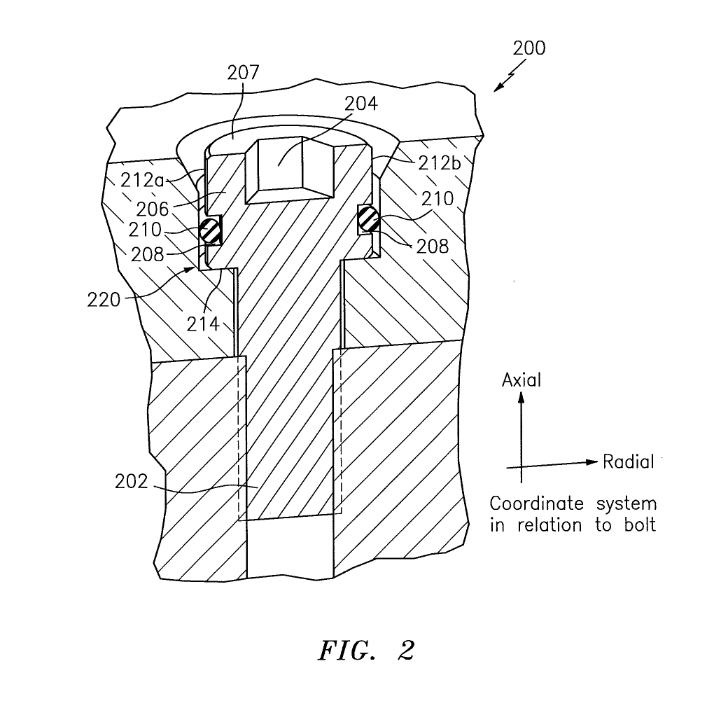

Referring to FIG. 2, an exemplary system assembly 200 in accordance with aspects of the disclosure is shown. For purposes of illustration, axial and radial reference directions with respect to the assembly 200 are shown/superimposed in FIG. 2.

The assembly 200 may include a bolt 202. The bolt 202 may include a feature 204, such as for example an internal feature, to enable the bolt 202 to be tightened. The feature 204 may be formed in a head 206 of the bolt 202, interfacing with a top side/surface 207 of the head 206. The feature 204 may be compliant with, or be configured in accordance with, one or more profiles. For example, such profiles may include a hex profile, a 6-point star-shaped profile (e.g., TORX), a flat/regular screwdriver profile, a Phillips head profile, etc.

Formed within a first side 212a, a second side 212b (that may be substantially diametrically opposite the first side 212a), or at a bottom/lower surface 214 of the head 206 of the bolt 206 may be one or more grooves 208 that may accommodate/seat one or more seals 210. The seal(s) 210 may be used to isolate a first fluid from one or more additional fluids. In some embodiments, the first fluid may include oil and the one or more additional fluids may include air.

A seal 210 may be metallic or non-metallic. A seal 210 may seal radially against a counter bore (generally denoted as reference character 220) that the bolt 202 is coupled to (e.g., threaded into). The counter bore 220 may be oiled and tapered to accept the seal(s) 210. The seal(s) 210 may be lubricated upon/during installation.

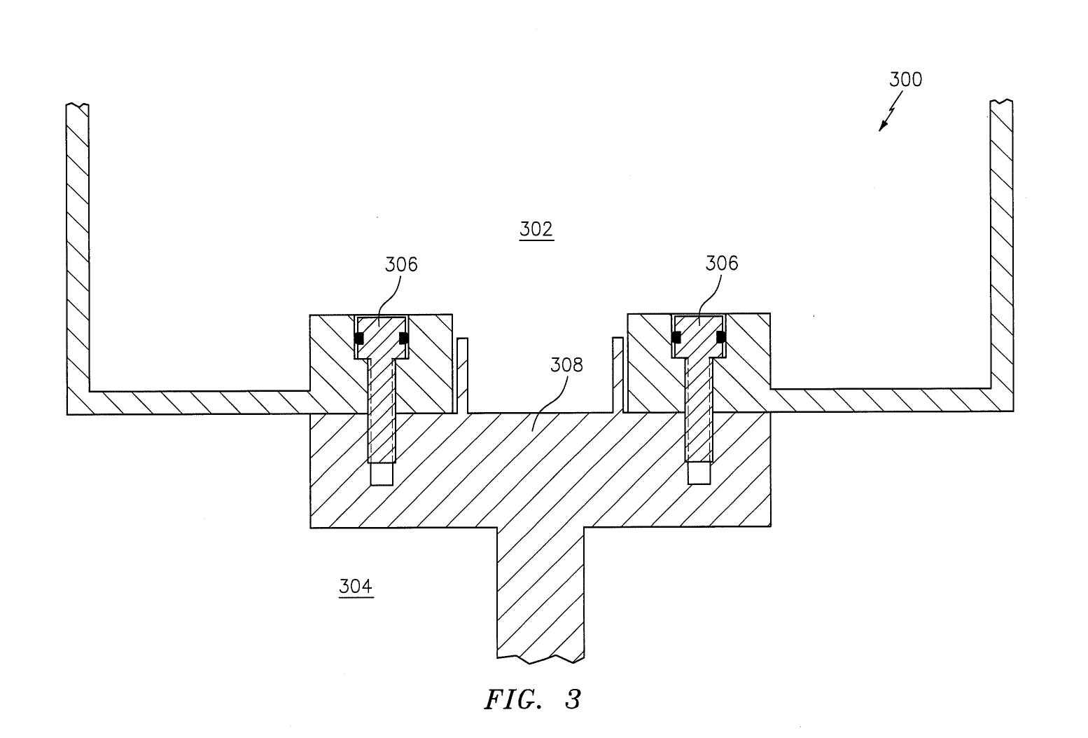

The groove(s) 208 may be configured (e.g., a dimension or size of the groove(s) 208 may be selected) to accommodate whatever type of seal 210 is appropriate for a given application, such as in connection with the bearings 36 of FIG. 1 or an associated bearing compartment 300 as shown in FIG. 3. In this manner, a standard/consistent surface area proximate the bolt head 206 may be provided for such an application. For example, an o-ring seal, a c-seal (e.g., a metal c-seal, a polytetrafluoroethylene (PTFE) c-seal), etc., may seal radially and may enable a standard torque to be applied to the bolt 202/feature 204.

Referring to FIG. 3, a side perspective view of a bearing compartment 300 is shown. A forward (fwd) reference direction is superimposed in FIG. 3 via the dashed arrow, and the reference characters 302 and 304 generally refer to the inside of the compartment (e.g., the oil side) and the outside of the compartment (e.g., the air side), respectively. Reference character 306 denotes the bolted interface where the seals may be located. Reference character 308 denotes a tube that the bolts may thread into.

Based on the use of the assembly 200, any oil within the bearing compartment may be prevented from leaking out of the bearing compartment at the location of the seals 210. In other words, the area of the assembly 200 below the seals 210 in FIG. 2 may remain “oil free” or substantially “oil free” (e.g., any trace amount of oil may be less than a threshold).

Aspects of the disclosure may be applied in connection with one or more aerospace environments. For example, aspects of the disclosure may be applied in connection with an engine of an aircraft. Aspects of the disclosure may be applied in connection with other application environments, including air-air seals, air-oil seals, fluid-fluid seals, non-tube locations (such as caps, plugs, or bolted supports), etc.

Technical effects and benefits of this disclosure include an enhancement or extension of a sealing capability associated with a bearing compartment. In accordance with aspects of this disclosure, a radial seal may prevent/minimize a leakage of oil in proximity to a head of a bolt. The sealing capability may be independent of bolt torque/preloading and may be based on a bolt head being located within or proximate to a counter bore.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

What is claimed is:

1. An assembly associated with an engine of an aircraft, comprising:
a bolt comprising at least one groove; and
at least one seal seated within the at least one groove,
wherein the at least one seal is configured to seal radially against a counter bore that the bolt is coupled to.

2. The assembly of claim 1, wherein the at least one groove is formed in a head of the bolt.

3. The assembly of claim 2, wherein the at least one groove is formed in a side of the head.

4. The assembly of claim 1, wherein the at least one groove comprises at least two grooves, and wherein the at least one seal comprises a first seal seated within a first of the at least two grooves and a second seal seated within a second of the at least two grooves.

5. The assembly of claim 1, further comprising:
an internal feature configured to enable the bolt to be tightened.

6. The assembly of claim 5, wherein the internal feature is formed in a head of the bolt.

7. The assembly of claim 5, wherein the internal feature is compliant with one of a hex profile, a 6-point star-shaped profile, a flat screwdriver profile, or a Phillips head profile.

8. The assembly of claim 1, wherein the assembly is incorporated into a bearing compartment of the engine.

9. The assembly of claim 8, wherein the assembly is configured to prevent oil contained within the bearing compartment from leaking out of the bearing compartment.

10. The assembly of claim 1, wherein the at least one seal comprises at least one of an o-ring seal or a c-seal.

11. The assembly of claim 1, wherein the at least one seal comprises a metallic seal.

12. The assembly of claim 1, wherein the at least one seal comprises a non-metallic seal.

13. A bolt comprising:
a head;
a first groove formed in a first side of the head and configured to seat a first seal; and
an internal feature formed in the head and interfacing with a surface of the head,
wherein the internal feature is configured to enable the bolt to be tightened.

14. The bolt of claim 13, wherein the bolt is configured to be incorporated into an engine of an aircraft.

15. The bolt of claim 14, wherein the bolt is configured to be incorporated into a bearing compartment of the engine.

16. The bolt of claim 13, wherein the internal feature is compliant with one of a hex profile, a 6-point star-shaped profile, a flat screwdriver profile, or a Phillips head profile.

17. The bolt of claim 13, further comprising:
a second groove formed in a second side of the head and configured to seat a second seal,
wherein the second side of the head is substantially diametrically opposite the first side of the head.

18. The bolt of claim 13, wherein the first groove is configured to seat the first seal such that the first seal seals radially against a counter bore.

19. The bolt of claim 13, wherein the first groove is configured to seat an o-ring seal or a c-seal as the first seal.
